(19) United States
(12) Patent Application Publication
(10) Pub. No.: US 2009/0065596 A1
(43) Pub. Date: Mar. 12, 2009

(54) SYSTEMS AND METHODS FOR INCREASING BUILDING SPACE COMFORT USING WIRELESS DEVICES

(75) Inventors: John E. Seem, Glendale, WI (US); James S. Botic, New Berlin, WI (US); Jerald P. Martocci, Greenfield, WI (US); Anderlyne M. Canada, Milwaukee, WI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 12/181,258

(22) Filed: Jul. 28, 2008

Related U.S. Application Data
(63) Continuation-in-part of application No. 11/801,143, filed on May 9, 2007.
(60) Provisional application No. 60/962,697, filed on Jul. 31, 2007.

(51) Int. Cl. G05D 23/00; G05B 15/00

(52) U.S. Cl. 236/51; 700/278

(57) ABSTRACT

A method for providing control to a building zone uses a building automation system and a portable wireless device located within the building zone. The method includes the step of identifying the portable wireless device using wireless communications. The method further includes retrieving information from a memory device specific to the identified portable wireless device. The retrieved information comprises a user preference relating to the building automation system. The method further includes adjusting a parameter of the building automation system based on the retrieved information.

### CROSS REFERENCE TO RELATED APPLICATIONS

This is a continuation-in-part of application Ser. No. 11/801,143, filed May 9, 2007, the entire disclosure of which is incorporated by reference. This application also claims the benefit of U.S. Provisional Application No. 60/962,697, filed Jul. 31, 2007, the entire disclosure of which is incorporated by reference.

### BACKGROUND

The present disclosure generally relates to building systems. The present disclosure relates more specifically to wireless devices of a building system.

Different people often prefer different environmental conditions. For example, one person might prefer his or her working space to be 68° F. while another person might prefer his or her working space to be 74° F. It would be advantageous for a building automation system (BAS) to provide control of environmental conditions reflecting individual preferences to the extent possible.

### SUMMARY

The invention relates to a method for providing control to a building zone. The method uses a building automation system and a portable wireless device located within the building zone. The method includes the step of identifying the portable wireless device using wireless communications. The method further includes retrieving information from a memory device specific to the identified portable wireless device. The retrieved information comprises a user preference relating to the building automation system. The method further includes adjusting a parameter of the building automation system based on the retrieved information.

The invention also relates to a controller adjusting a building automation system using a portable wireless device located within a building zone. The controller includes a communications device configured to receive first information from the portable wireless device located within the building zone. The controller also includes a memory device storing second information specific to the first information. The controller further includes a processing circuit configured to retrieve the second information from the memory device and configured to receive the first information from the wireless sensor. The processing circuit retrieves the second information by identifying the first information and accessing the second information from the memory device. The processing circuit is further configured to adjust a building automation system setting based on the retrieved second information.

The invention also relates to a system for providing control to a building zone using a building automation system and a portable wireless device located within the building zone. The system includes a sensor configured to identify the portable wireless device using wireless communications. The system further includes a processing circuit communicably coupled to the sensor and configured to retrieve information from a memory device, the retrieved information specific to the identified portable wireless device. The processing circuit is further configured to adjust a setting of the building automation system using the retrieved information specific to the identified portable wireless device.

The invention also relates to a computer readable medium storing program code for causing a controller to provide control to a building zone using a building automation system and a portable wireless device located within the building zone. The computer readable medium includes program code for identifying the portable wireless device using wireless communications. The computer readable medium further includes program code for retrieving information from a memory device, the retrieved information specific to the identified portable wireless device, wherein the retrieved information comprises a user preference relating to the building automation system. The computer readable medium yet further includes program code for adjusting the building automation system parameter based on the retrieved information.

The invention further relates to a server computer configured to provide program code to a client computer, the program code for causing the client computer to provide control to a building zone using a building automation system and a portable wireless device located within the building zone. The server computer includes a communications interface for communicating with the client computer. The server computer further includes a processing circuit for accessing a memory device storing the program code. The program code includes program code for identifying the portable wireless device using wireless communications and program code for retrieving information from a memory device. The retrieved information is specific to the identified portable wireless device and the retrieved information comprises a user preference relating to the building automation system. The program code further includes program code for adjusting the building automation system parameter based on the retrieved information.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a cut-away perspective view of a building having a plurality of devices, according to an exemplary embodiment;

FIG. 2 is a schematic diagram of a building automation system for the building of FIG. 1, according to an exemplary embodiment;

FIG. 3 is a block diagram of a heating, ventilation, and air conditioning controller for the building automation system of FIG. 2, according to an exemplary embodiment;

FIG. 4 is a close-up perspective view of a building area, according to an exemplary embodiment;

FIG. 5A is a block diagram of a control system for adjusting a building automation system using a portable wireless device located within the building zone, according to an exemplary embodiment;

FIG. 5B is a block diagram of a database of the control system of FIG. 5A, according to an exemplary embodiment;

FIG. 6 is a perspective view of a building area, according to another exemplary embodiment;

FIG. 7A is a diagram of a system for updating user preferences, including an interface, according to an exemplary embodiment;

FIG. 7B is a diagram of a system for updating user preferences, including an interface, according to another exemplary embodiment;

FIG. 8 is a flow chart of a process for adjusting the settings of a building area, according to an exemplary embodiment;

FIG. 9 is a flow chart of a process for providing a user interface configured to allow a user to change personalized settings, according to an exemplary embodiment;

FIG. 10 is a block diagram of a hospital system for providing individual building automation system control, according to an exemplary embodiment;

FIG. 11 is a flow chart of a process for adjusting environment settings for detected occupants of a hospital area, according to an exemplary embodiment; and

FIG. 12 is a flow chart of a process of a tracking and alerting system for a hospital system, according to an exemplary embodiment.

### DETAILED DESCRIPTION OF THE EXEMPLARY EMBODIMENTS

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Referring generally to the figures, systems and methods for adjusting environment conditions based on user identification are disclosed. Such a system or method may wirelessly detect an occupant of a zone, area, space, room, workstation, desk, or other building area by communicating with a portable wireless device carried by the user. The user is identified and settings for various environmental preferences are recalled from a memory device using the identification information. The recalled environmental preferences can then be used by a local BAS controller or a supervisory BAS controller to update an environmental control strategy or BAS device setting. For example, in a room where a specific user is detected and identified, temperature preferences for the user are retrieved and the system responds to the retrieved temperature preferences by adjusting one or more HVAC setpoints accordingly.

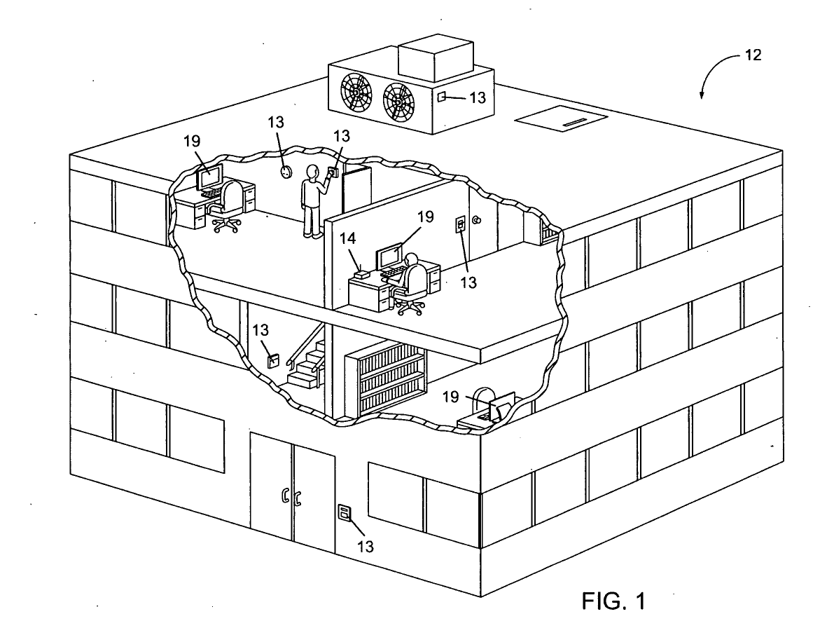

FIG. 1 is a perspective view of a building 12 having a plurality of devices 13 capable of transmitting and/or receiving signals, according to an exemplary embodiment. As illustrated, building 12 may include any number of zones, floors, rooms, spaces, and/or other building structures and areas. According to various exemplary embodiments, building 12 may be any zone of any size or type, including an outdoor area. Devices 13 may exist inside or outside the building, on walls or on desks, be user interactive or not, and may be any type of device. For example, devices 13 may be security devices, light switches, fan actuators, temperature sensors, thermostats, smoke detectors, occupancy sensors, other various types of sensors (flow, pressure, etc.), etc. Devices 13 may be configured to conduct building automation functions (e.g., sense temperature, sense humidity, control a building automation device, etc.). Devices 13 may also (or alternatively) serve any number of network functions (e.g., RF measuring functions, network routing functions, etc.). A controller system 14 is shown as a desktop wireless device. Controller system 14 may serve as a network coordinator, wireless access point, router, switch, or hub, and/or serve as another node on a network. A workstation 19 is shown as a personal workstation. Workstation 19 may allow building engineers to interact with controller system 14. Devices 13 may be connected to controller system 14 and/or workstation 19 via a wired and/or wireless connection.

A building automation system (BAS) is, in general, a hardware and/or software system configured to control, monitor, and manage equipment in or around a building or building zone. BAS equipment can include an HVAC system, a security system, a lighting system, a fire alerting system, an elevator system, another system that is capable of managing building functions, or any combination thereof. The BAS can control the environment (e.g., one or more environmental conditions of the environment) of one or more building zones. The BAS as illustrated and discussed in the present disclosure is an example of a building automation system that may be used in conjunction with the systems and methods of the present disclosure. However, other building automation systems may be used as well.

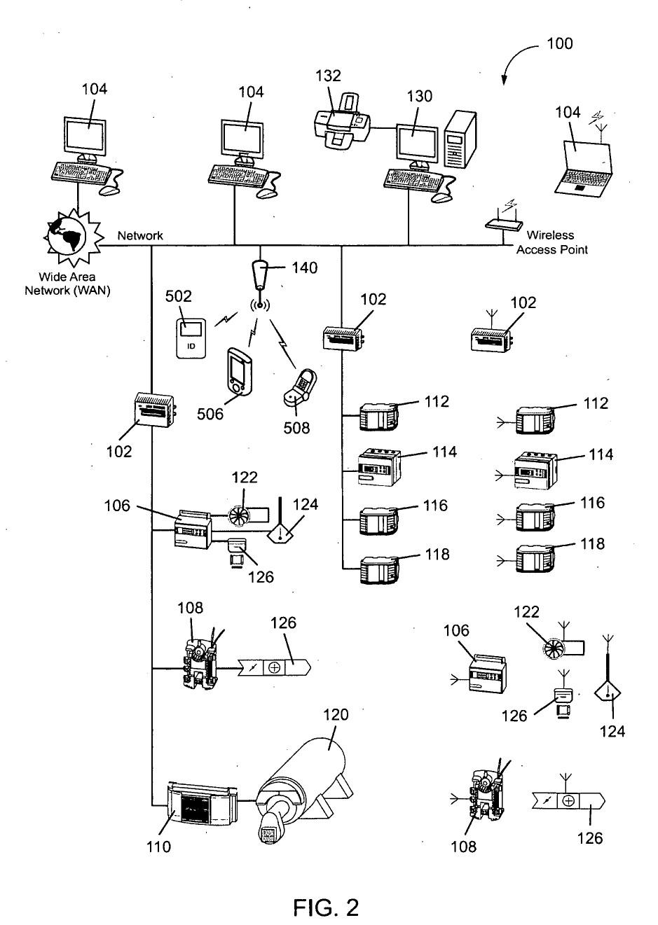

Referring to FIG. 2, a schematic diagram of a BAS 100 that may be used with the systems and methods of the present disclosure is shown, according to an exemplary embodiment. BAS 100 may include one or more supervisory controllers (e.g., a network automation engine (NAE)) 102 connected to a proprietary or standard communications network such as an IP network (e.g., Ethernet, WiFi, ZigBee, Bluetooth, etc.). Supervisory controllers 102 may support various field-level communications protocols and/or technology, including various Internet Protocols (IP), BACnet over IP, BACnet Master-Slave/Token-Passing (MS/TP), N2 Bus, N2 over Ethernet, Wireless N2, LonWorks, ZigBee, and any number of other standard or proprietary field-level building management protocols and/or technologies. Supervisory controllers 102 may include varying levels of supervisory features and building management features. The user interface of supervisory controllers 102 may be accessed via terminals 104 (e.g., web browser terminals) capable of communicably connecting to and accessing supervisory controllers 102. For example, FIG. 2 shows multiple terminals 104 that may variously connect to supervisory controllers 102 or other devices of BAS 100. For example, terminals 104 may access BAS 100 and connected supervisory controllers 102 via a WAN, an Internet location, a local IP network, or via a connected wireless access point. Terminals 104 may also access BAS 100 and connected supervisory controllers 102 to provide information to another source, such as printer 132.

Supervisory controllers 102 may be connected to any number of BAS devices. The devices may include, among other devices, devices such as field equipment controllers (FECs) 106 and 110 such as field-level control modules, variable air volume modular assemblies (VMAs) 108, integrator units, room controllers 112 (e.g., a variable air volume (VAV) device or unit), other controllers 114, unitary devices 116, zone controllers 118 (e.g., an air handling unit (AHU) controller), boilers 120, fan coil units 122, heat pump units 124, unit ventilators 126, expansion modules, blowers, temperature sensors, flow transducers, other sensors, motion detectors, actuators, dampers, heaters, air conditioning units, etc. These devices may generally be controlled and/or monitored by supervisory controllers 102. Data generated by or available on the various devices that are directly or indirectly connected to supervisory controllers 102 may be passed, sent, requested, or read by supervisory controllers 102 and/or sent to various other systems or terminals 104 of BAS 100. The data may be stored by supervisory controllers 102, processed by supervisory controllers 102, transformed by supervisory controllers 102, and/or sent to various other systems or terminals 104 of the BAS 100. As shown in FIG. 2, the various devices of BAS 100 may be connected to supervisory controllers 102 with a wired connection or with a wireless connection.

Still referring to FIG. 2, an enterprise server 130 (e.g., an application and data server (ADS)) is shown, according to an exemplary embodiment. Enterprise server 130 is a server system that includes a database management system (e.g., a relational database management system, Microsoft SQL Server, SQL Server Express, etc.) and server software (e.g., web server software, application server software, virtual machine runtime environments, etc.) that provide access to data and route commands to BAS 100. For example, enterprise server 130 may serve user interface applications. Enterprise server 130 may also serve applications such as Java applications, messaging applications, trending applications, database applications, etc. Enterprise server 130 may store trend data, audit trail messages, alarm messages, event messages, contact information, and/or any number of BAS-related data. Terminals may connect to enterprise server 130 to access the entire BAS 100 and historical data, trend data, alarm data, operator transactions, and any other data associated with BAS 100, its components, or applications. Various local devices such as printer 132 may be attached to components of BAS 100 such as enterprise server 130.

Referring further to FIG. 2, BAS 100 is shown to a receiver (or receivers or transceivers) 140 configured to accept a signal or input from various portable wireless devices (e.g., RFID tag 502, personal digital assistant (PDA) 506, wireless device 508, etc.). Receiver 140 is configured to provide another signal (e.g., indicia of the first signal) or to relay a representation of the first signal to supervisory controllers 102 and/or other components of BAS 100. Using information from receiver 140 the supervisory controller 102 and/or another supervisory controller (e.g., enterprise server 130) are configured to send updated BAS control signals to field level devices and/or actuators (e.g., field controller 106, zone controllers 118, etc.).

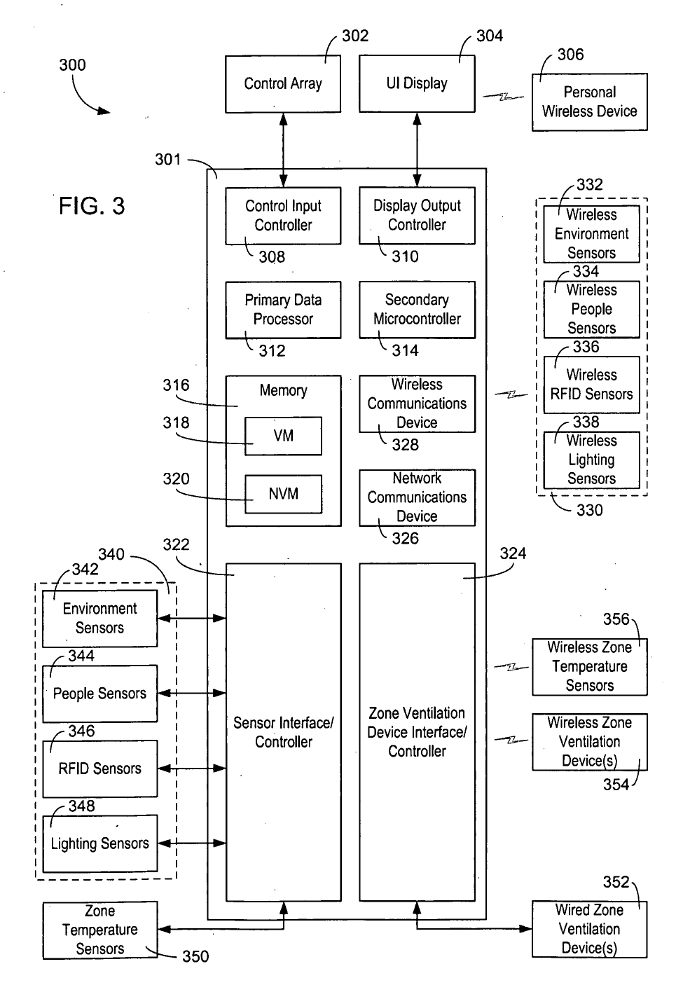

Referring to FIG. 3, a block diagram of a BAS control system 300 is shown, according to an exemplary embodiment. BAS control system 300 may be used by the systems and methods of the present disclosure to adjust one or more environmental conditions that affect building zone comfort.

BAS control system 300 may include a controller 301, a plurality of sensors, control array 302, and a graphical user interface display 304. BAS control system 300 may be an HVAC control system capable of controlling HVAC variables or setpoints provided to a plurality of building zones, an entire building, or a single zone. Controller 301 can be a supervisory controller, a local controller, a field level controller, an enterprise controller, or any other type of controller configured to affect environmental conditions of a building zone.

While many various components of BAS control system 300 are shown integrated into a controller 301, it should be appreciated that distributed BAS systems, such as the METASYS® building automation system sold by Johnson Controls, Inc., and/or BAS 100 shown in FIG. 2, may include one or more supervisory controllers, one or more enterprise servers, one or more communications networks, and one or more field controllers connected to the supervisory controllers or enterprise servers via the communications network. The field controller may be capable of driving any number of other field controllers or devices. According to other alternative embodiments, controller 301 may have fewer components and may be integrated into an actuator for a single damper that controls ventilation to a relatively small (e.g., single room) zone. According to yet other alternative embodiments, controller 301 may be installed in the residential context in a home air handler, air conditioner, fan unit, or furnace.

Controller 301 may include a primary data processor 312, a secondary microcontroller 314, a memory 316, a sensor interface/controller 322, a zone ventilation device interface/controller 324, a network communications device 326, a wireless communications device 328, a control input controller 308, and a display output controller 310. The components of controller 301 may be contained in a single housing or distributed around the various building zones of a building.

Primary data processor 312 may be communicably coupled to the various other components of BAS control system 300 and is generally configured to control each function of controller 301. Primary data processor 312 may include digital or analog processing components and/or be of any design that facilitates control or features of BAS control system 300. Primary data processor 312 may be a single data processing device or multiple data processing devices. Primary data processor 312 may include any combination of program software (e.g., computer code, script code, executable code, object code, etc.) and hardware capable of providing control, display, communications, input and output features to BAS control system 300. For example, primary data processor 312 may include any number of additional hardware modules, software modules, or processing devices (e.g., additional graphics processors, communications processors, etc.). Primary data processor 312 and/or secondary microcontroller 314 may coordinate the various devices, components and features of BAS control system 300 (e.g., memory 316, sensor interface/controller 322, zone ventilation interface/controller 324, etc).

Memory 316 is configured to store data accessed by BAS control system 300 or controller 301. For example, memory 316 may store data input from zone sensors and actuators, data created by primary data processor 312 that may be used later, intermediate data of use in a current calculation or process, or any other data of use by BAS control system 300. Memory 316 may include both a volatile memory 318 and a non-volatile memory 320. Volatile memory 318 may be configured so that the contents stored therein may be erased during each power cycle of the controller 301. Non-volatile memory 320 may be configured so that the contents stored therein may be retained across power cycles, such that upon controller 301 power-up or reset, data from previous system use remains available to the controller or user. According to an exemplary embodiment, non-volatile memory 320 may store any number of databases, tables, or profiles for use with the various zones or functions of BAS control system 300. According to other exemplary embodiments, controller 301 may access remote data stores or servers via wired or wireless networks.

Sensor interface/controller 322 may be a device or set of devices configured to facilitate signal connections between a set of building zone sensors 340 and controller 301. Sensor interface/controller 322 may use any number of hardware technologies and/or software protocols to accomplish necessary connections and or communications with sensors such as environment sensors 342, people sensors 344, RFID sensors 346, lighting sensors 348, zone temperature sensors 350, and any number of additional sensors or devices (e.g., security devices, smoke alarms, etc.). Sensor interface/controller 322 may also be wired or connected to wireless receivers distributed around a building zone. For example, sensor interface/controller 322 may be coupled to a wireless transceiver or receiver configured to identify people occupying a building zone.

Zone ventilation device interface/controller 324 may be a device or set of devices configured to facilitate functional connections between a set of zone ventilation devices (e.g., wired zone ventilation devices 352, wireless zone ventilation devices 354, etc.) and controller 301. Zone ventilation device interface/controller 324 may use any number of hardware technologies and/or software protocols to accomplish necessary connections and/or communications with zone ventilation devices. Zone ventilation device interface/controller 324 may also use wireless technology and/or may be communicably connected to wireless communications device 328 to accomplish communications with wireless zone ventilation devices 354. Zone ventilation devices 352, 354 may include any number of local control circuits, sensors, and/or actuators that may be used to facilitate local or device level control of the various zone ventilation devices of BAS control system 300.

Network communications device 326 is generally configured to provide a connection to a data communications network such as an Ethernet-based LAN or WAN. According to other various embodiments, network communications device 326 is a wireless network communications device. Users of the BAS control system 300 may use network communications device 326 to perform remote control functions and/or to connect distributed components of controller 301 or the HVAC control system. Network communications device 326 and/or wireless communications device 328 may also be connected to a building-wide or multiple-zone HVAC system, network, network automation engine, and/or application data server. These components may be a part of the METASYS® building automation system sold by Johnson Controls, Inc. or other available building management systems.

Wireless communications device 328 is generally configured to establish communication links with wireless sensors and actuators of HVAC control system 300. Wireless communications device 328 may be configured to use any variety of wireless communications technologies or topologies (e.g., mesh topology, star, etc.). According to an exemplary embodiment, building zones may be partially wireless and partially wired. Wireless communications device 328 may connect to any number of various zones sensor sets 330 that may include sensors such as wireless environment sensors 332, wireless people sensors 334, wireless RFID sensors 336, and/or wireless lighting sensors 338. Wireless communications device 328 may also connect to any other wireless sensor such as wireless zone ventilation devices 354, wireless zone temperature sensors 356, and/or any other type of wireless device including intermediate wireless access points, coordinators, routers, and/or gateways.

Controller 301 may also include any number of secondary microcontrollers 314 that may be configured to compute or process various functions of BAS control system 300. Controller 301 may also include control input controller 308 and display output controller 310 that may be communicably connected to control array 302 and/or graphical user interface display 304. Using these devices, controller 301 may be able to serve as a standalone device, not requiring the use of a separate networked workstation or browser to control various features of controller 301. Controller 301 may also communicate with a portable wireless device 306 (e.g., cell phone, PDA, or any other device with transmitting capability) for use as a sensor monitored by the system.

The various sensors 330-348 include communications hardware and/or software for communicating with components of BAS control system 300 (or any other system). For example, the sensors may be of any wired or wireless technology capable of communicating sensed information back to BAS control system 300. According to one exemplary embodiment, the sensors are wireless-capable sensors configured to operate with 802.15 standards and protocols (e.g., ZigBee compatible wireless-capable sensors, etc.).

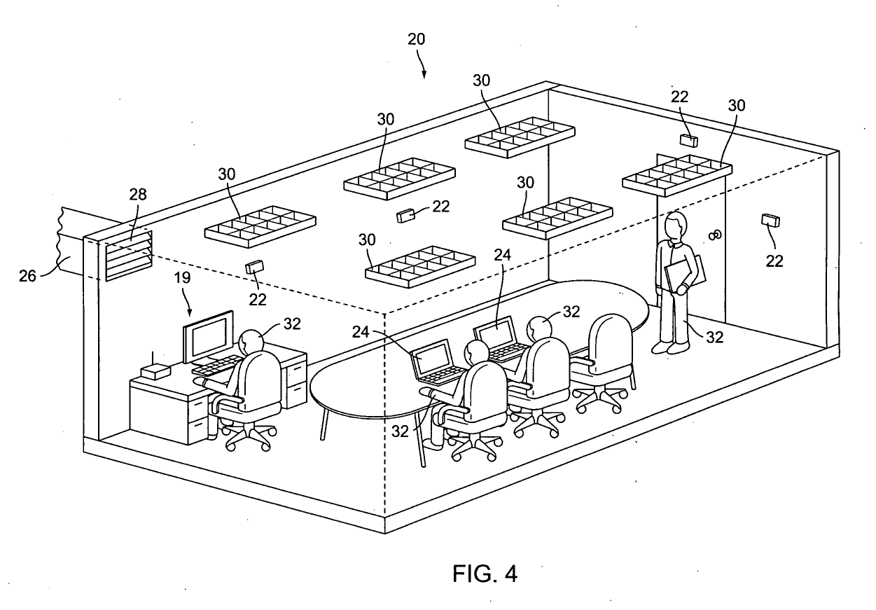

Referring to FIG. 4, a perspective view of a building zone 20 is shown, according to an exemplary embodiment. Building zone 20 includes an HVAC vent 26 coupled to ductwork. Supply air flow or ventilation may be provided to zone 20 via vent 26. Building zone 20 may also include lights 30, workstations or other equipment 19, laptops 24, people 32, and one or more sensors 22. Building zone 20 may include any number of additional or alternative objects, equipment, structures, surfaces, people, and/or lights.

Sensors 22 may be disposed within and/or around building zone 20 and may be configured to sense portable wireless devices (e.g., laptops 24) that may move around building zone 20. Sensors 22 are shown disposed on the walls of building zone 20, but may be located, positioned, or disposed in any manner or location within building zone 20 (e.g., near a door, on a ceiling, in a floor, etc.). Sensors 22 may have any number of user interface and/or communications features configured to facilitate their operation with various control systems of a BAS. Sensors 22 may be wireless or wired sensors configured to operate on a mesh network or to operate on or with any other network topology. Portable wireless devices may be associated with people 32, laptops 24, or any other mobile object within building zone 20.

Sensors 22 may be configured to detect any portable wireless device (e.g., a PDA, cell phone, RFID tag, etc.) within building zone 20. For example, a person 31 wearing an RFID tag may be detected by a sensor 22 and the specific identity of person 31 may be determined during the detection (e.g., by reading a unique identifier included with the RFID tag).

According to one exemplary embodiment, sensors 22 may include capabilities in addition to wireless portable device identification capabilities. For example, sensors 22 may be temperature sensors, humidity sensors, air quality sensors, equipment sensors, person sensors, lighting sensors, heat transferring object sensors, infrared sensors, and/or any other type of BAS device.

According to an exemplary embodiment, sensors 22 may use the identification of a portable wireless device and/or a person in conjunction with a sensed condition to provide a changed setting for building zone 20. For example, one sensor 22 may identify a person 32 via a mobile phone carried by person 32 and use the identification to determine if a temperature sensed by sensor 22 is at a preferred level for person 32. Based on the determination, sensor 22 can communicate an alert to its supervisory controller, can communicate an identifier for the portable wireless device to its supervisory controller, can calculate a new setpoint, and/or can make any other determination relating to having access to both identifier information (and/or related user preferences) and an actual condition of a building zone.

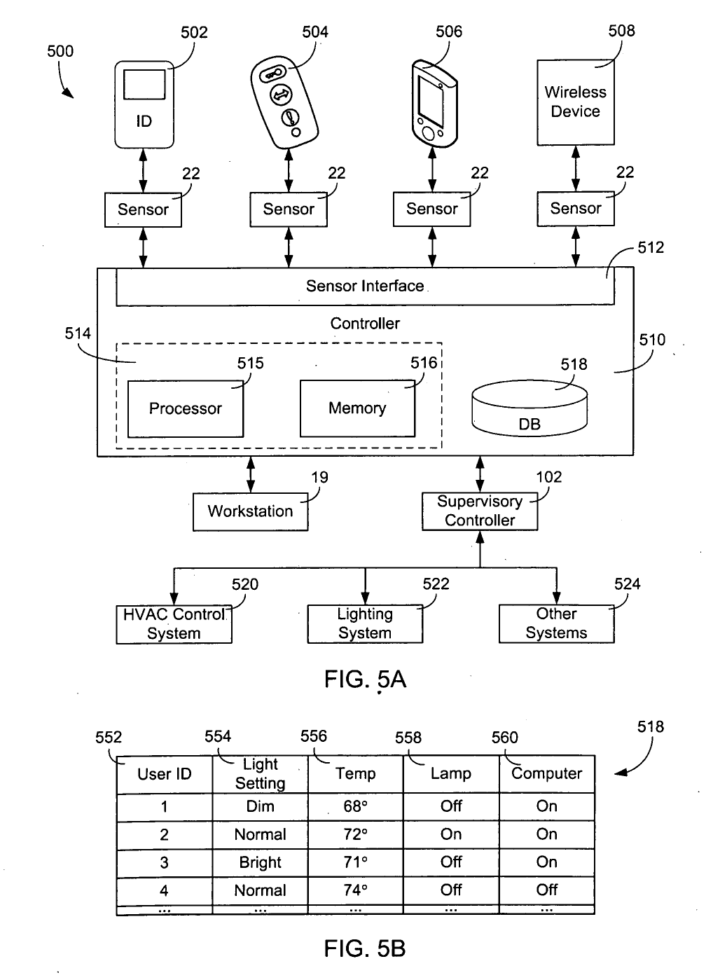

Referring to FIG. 5A, a block diagram of an environment control system 500 is shown, according to an exemplary embodiment. Environment control system 500 is an example of a system that can be integrated with a BAS (and/or BAS components such as supervisory controller 102) to provide the activities described in the present application. System 500 is shown to include a controller 510 (e.g., a personal environment module (PEM)) configured to communicably couple the various components of system 500 together and/or to conduct the computational activities of system 500 relating to personal identification.

Controller 510 is shown to include a processing circuit 514 and a database 518. Processing circuit 514 includes a processor 515 for processing received identification information and a memory device 516 (which may include a collection of multiple memory devices) for storing identification information for future use. Controller 510 is shown as coupled to supervisory controller 102 (e.g., using a wireless and/or wired network connection) which may be used to relay information and otherwise communicate with the various subsystems of system 500. System 500 may be implemented for a single building zone, area, space, or room (e.g., building zone 20 of FIG. 4) and control a single HVAC control loop, or may be implemented in a larger zone where multiple systems are managed (e.g., multiple HVAC control loops and/or multiple lighting systems).

Various portable wireless devices are shown that are capable of providing identification information to controller 510. For example, ID tag 502 (e.g., a RFID tag) may provide controller 510 with a unique identifier and/or information regarding the user associated with ID tag 502. Key fob 504 is an example of another device that may provide controller 510 with identification information. A PDA 506 or other wireless device 508 may also be used to provide identification information for controller 510. Wireless data communication technologies or protocols such as 802.xx protocols, Bluetooth protocols, or any other wireless protocol may be used to identify portable wireless devices users may carry. Sensors 22 (e.g., RFID sensors 336 and/or 346 of FIG. 3) may be used to receive signals from devices 502-508 and to provide the signals to controller 510. Sensors 22 can be configured to broadcast signals that will excite and/or trigger a response from the portable wireless devices. Controller 510 includes a sensor interface 512 for receiving signals from devices 502-508 and/or sensors 22.

Controller 510 is shown to include database 518. Database 518 is shown in greater detail in FIG. 5B. Database 518 is shown as a table; however, database 518 may retain data in any data structure or file format. Database 518 may be configured to keep control setting information for users of a building zone. Database 518 may assign each user a user ID 552 to uniquely identify the user, along with various settings preferred by the user. For example, a lighting setting 554 (e.g., adjusting the brightness of the lights of the zone) and/or a temperature setting 556 may be set for a user. In addition, the operation of various devices of the zone (e.g., a lamp 558 or computer 560) may be adjusted to account for various users of the area.

Referring back to FIG. 5A, according to one exemplary embodiment, a user may use workstation 19 to edit settings stored in database 518 for a user. Alternatively, PDA 506 or another wireless device 508 may be used to access and change such settings.

Controller 510 may be coupled to supervisory controller 102 or may otherwise be a part of BAS 100. Controller 510 can receive a device identifier (e.g., from a sensor 22), look up setting data for the user, and provide supervisory controller 102 with the setting data. Supervisory controller 102 may provide the setting data to HVAC system 520 (e.g., a field controller of the HVAC system), lighting system 522, or any other system 524, component or device of the building zone for implementation.

According to various exemplary embodiments, all sensors 22 for a facility or building zone may be communicably coupled to controller 510. In this embodiment, controller 510 receives all identification information and provides supervisory controller 102 with setting data for all systems of the building zone. In this and in other embodiments, profile or setting data may effectively and consistently “follow” a user as the user moves from one zone to another within the facility or building zone.

Supervisory controller 102 may configured to include logic for performing system-wide changes in order to complete various changes at a local level (e.g., for controller 510). For example, controller 510 may detect a user and determine a change in temperature should be made in response. Controller 510 may then provide information regarding the change (e.g., information regarding the desired setpoint, information regarding increased airflow, information regarding changed temperature, etc.) to supervisory controller 102, which may determine that more outside air must be brought into the building in order to meet the temperature change for the building zone associated with local controller 510. Supervisory controller 102 can then be configured to use one or more actuators to adjust the amount of outside air brought into the system. Yet further, supervisory controller 102 can adjust the flow of a refrigerant used by a chiller or the flow of a gas provided to a boiler in order to affect the temperature of the air provided by the a head AHU (e.g., a rooftop AHU) or another system-level HVAC component or components. According to various exemplary embodiments, controller 510 can be configured to communicate change requests to supervisory controller 102 once controller 510 determines that it will not be able to make a change based on user preferences with the resources available to controller 510.

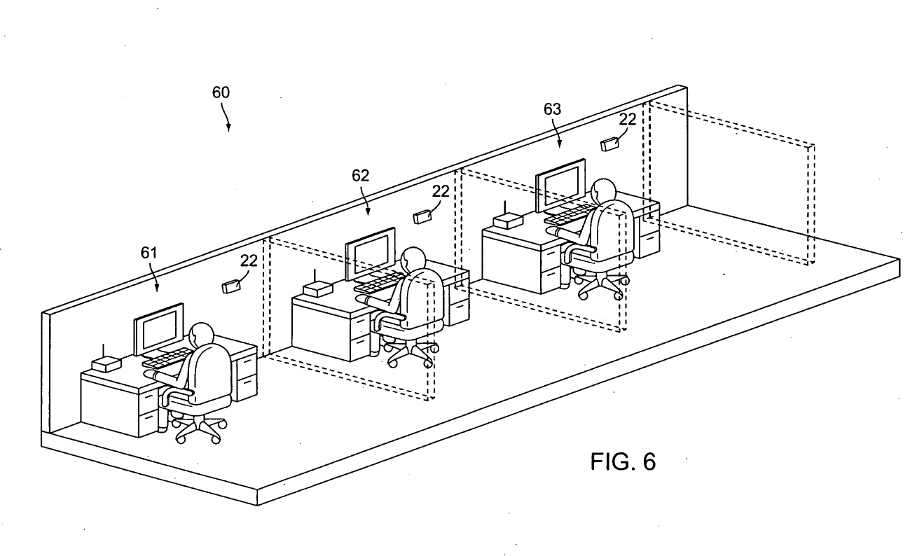

Referring now to FIG. 6, a building zone 60 is shown with multiple workstations 61, 62, 63. In building zone 60 with a plurality of workstations 61, 62, 63 (or other designated zones), each workstation having a similar desktop computer and lighting configuration, information regarding the identity of the users located within building zone 60 may be retrieved using a variety of different identification methods (e.g., identification based on login information, identification of a portable wireless device using sensors 65, 66, 67, identification using other components of workstations 61, 62, 63, such as a chair, etc.). Similarly, the identification of a user in the zone may be estimated using schedule and meeting information related to zone 60. For example, if a building zone such is reserved and/or otherwise scheduled for a particular user at a particular time, a database system may access preference information for the user to customize the environment of the building zone. For example, a workstation may be programmed to turn the lights to a particular setting or brightness, adjust ventilation to a user's pre-stored preference, adjust temperature, and/or to adjust other settings.

According to another example, building zone usage may be recorded and analyzed in the zone using identification information. Building zone usage data may include how often a building zone is occupied, who is occupying the building zone and at what times, etc. If a building zone is often used in a certain way due to preferences retrieved using identification information from sensors 65, 66, 67, a controller can determine an average preference and adjust a normal setpoint based on aggregate specific preferences. Further, if the same user is detected, settings for the user may be applied at the appropriate times. Additionally, the building zone usage data may be used to determine an optimal use for the zone (e.g., if a zone is not used for a particular time period, settings may be adjusted to optimize performance of other building systems).

According to various other exemplary embodiments, information regarding schedules, network connection information, and/or particular preferences for individuals may be used to predict heat, cooling, and/or ventilation loads for the zone.

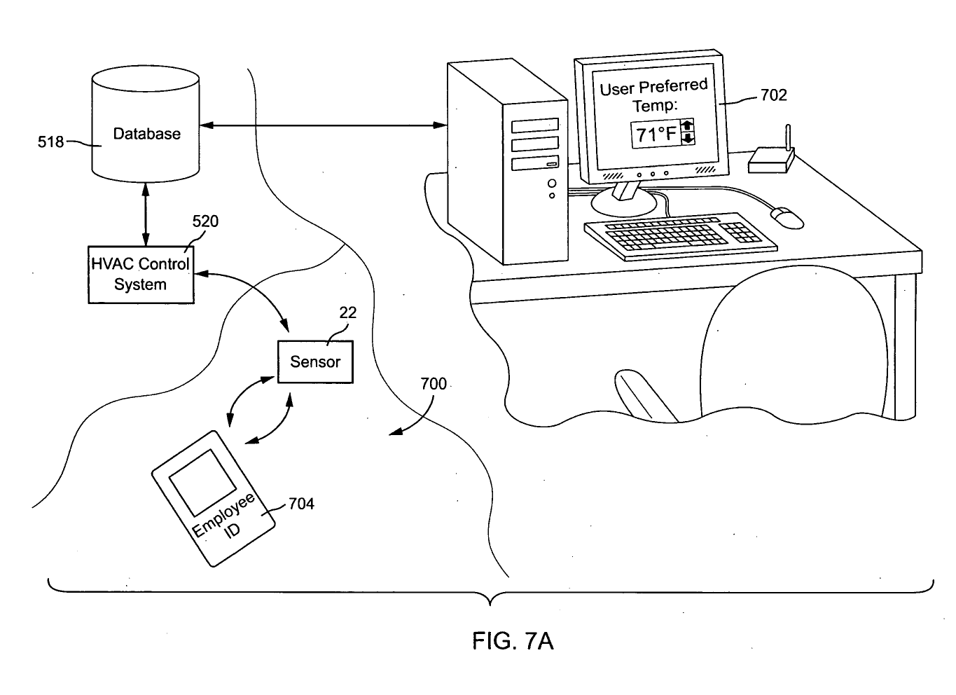

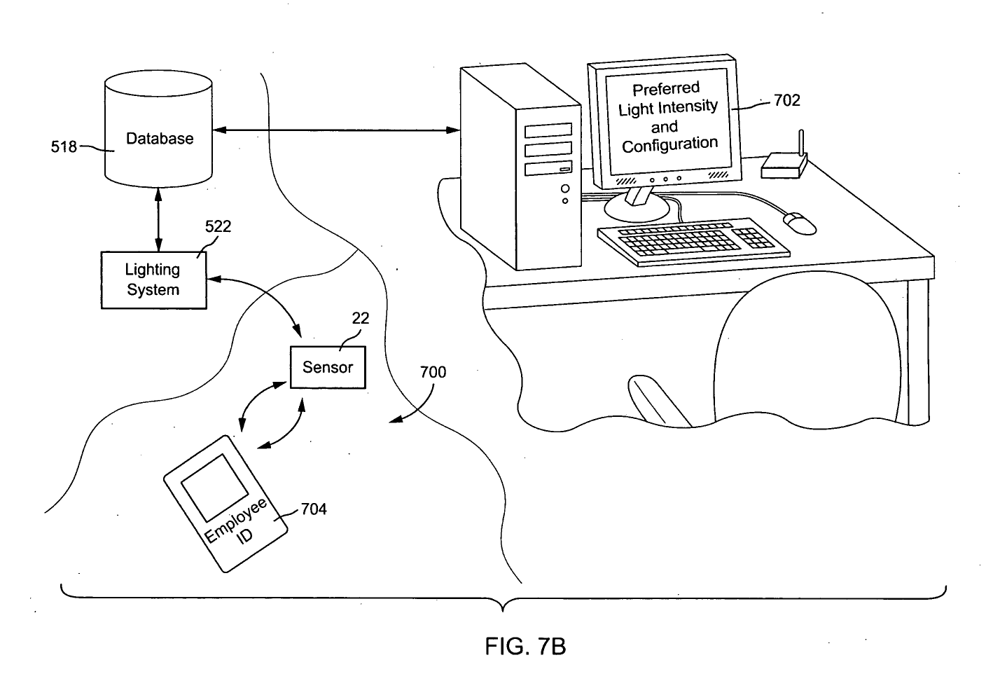

Referring now to FIGS. 7A-B, a control system 700 is shown for updating personal preference information associated with identifiers of portable wireless devices, according to exemplary embodiments. Control system 700 is shown to include sensor 22, database 518, and HVAC control system 520 and/or lighting system 522 of a specific building zone. System 700 of FIGS. 7A-B may be responsible for controlling one or more building zones (e.g., one or more of workstations 61, 62, 63 shown in FIG. 6).

Each user (e.g., via a portable wireless device) may be associated with personal environment control settings and may be able to login and access the settings via a user intranet, internet, or standalone application (e.g., via interface 702 shown in FIGS. 7A-B). Interface 702 may allow a user to specify any number of personal comfort settings, such as preferred temperature, that may be associated with a unique identifier for the person and/or the person's portable wireless device. Interface 702 may access information from and store information on database 518 (e.g., via one or more services, scripts, and/or applications residing on a local or remote computer). Database 518 may be communicably coupled to HVAC control system 520 of FIG. 7A, lighting system 522 of FIG. 7B, or another system. In FIG. 7A, interface 702 is shown to provide a user with a prompt for temperature information that may be relayed to database 518 and/or HVAC control system 520. In FIG. 7B, interface 702 provides a user with a prompt for lighting configuration options that may be relayed to database 518 and/or lighting system 522. According to other exemplary embodiments, database 518 may be integral or embedded in HVAC control system 520 and/or lighting system 522.

Whenever a user enters a building zone including a sensor 22 configured to sense the presence of the user or portable wireless device of the user (e.g., via an RFID sensor sensing the presence of an ID badge 704 or otherwise), sensor 22 may communicate with system 520 or 522 and database 518 via a BAS network or otherwise to retrieve information associated with the sensed portable wireless device. System 520 or 522 may use the information (e.g., preferred temperature or light setting, etc.) to determine a desired flow rate or setpoint of various HVAC, lighting, or other components relating to the building zone. For example, system 520 or 522 may provide an increase in room ventilation when the user enters the room. When multiple users are located and detected in the same room or other building zone, systems 520, 522 may be configured to use the preferred settings of a plurality of users in the building zone to arrive at an average (e.g., an average preferred temperature or light setting, median preferred temperature or light setting, etc.).

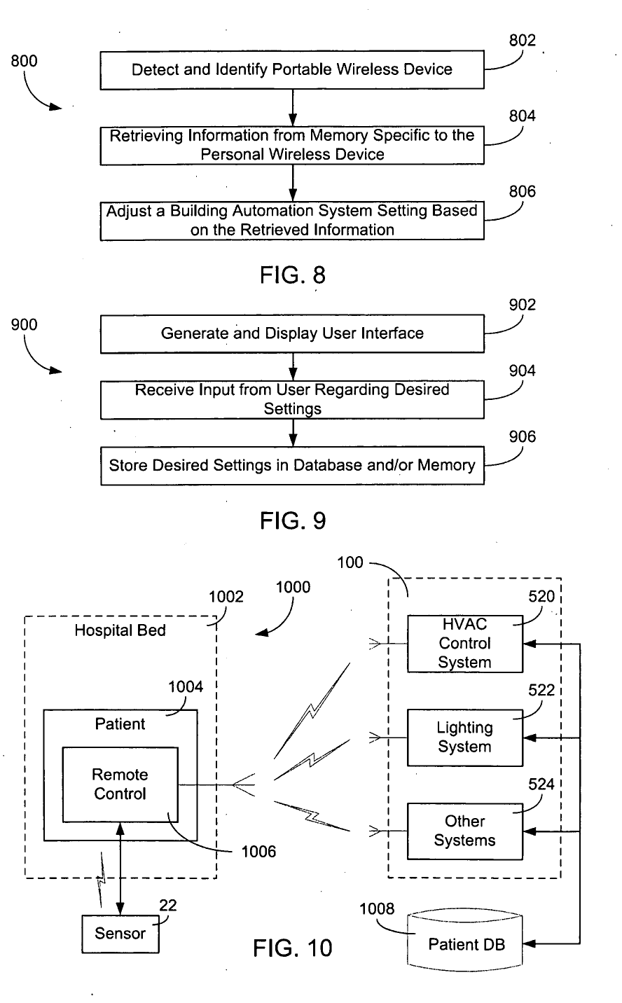

Referring to FIG. 8, a flow chart of a process 800 for adjusting the settings of a building zone is shown, according to an exemplary embodiment. A sensor (e.g., transceiver, transmitter/receiver pair, etc.) in and/or around the building area can detect the presence of and identify a user or a portable electronic device within the building zone (step 802). For example, the user may carry an RFID tag or a mobile phone that the sensor can detect and/or with which the sensor can wirelessly (e.g., using RF communications) communicate. The system can then retrieve information specific to the portable wireless device from a database or a memory device (step 804). The information specific to the portable wireless device can be a user preference relating to a building automation system. Process 800 is further shown to include adjusting the building automation system setting or parameter based on the retrieved information (step 806). The adjustments may include, for example, adjusting a temperature setting, adjusting a lighting setting, adjusting a fan setting, adjusting a white noise setting, and/or adjusting any other BAS setting, variable, or device to increase occupant comfort.

Referring now to FIG. 9, a flow chart of a process 900 for providing a user interface for updating user comfort preferences is shown, according to an exemplary embodiment. The user interface may be similar to interface 702 shown in FIGS. 7A and 7B. A control system can generate and display a user interface for use by a local and remote user for entering comfort preferences (step 902). The control system can receive the input (step 904) after various prompting by the user interface, and store or update the comfort preferences in a database and/or in memory configured to associate the preferences with a unique identifier of a user's portable electronic device (step 906). The comfort preferences can be used by, for example, process 800 to adjust a building automation system setting.

Referring now to FIG. 10, a block diagram of a hospital system 1000 is shown. Hospital system 1000 may be used in conjunction with the sensors, controller, and/or other system components shown in FIG. 5A or in the other figures of the present application, according to various exemplary embodiments. Hospital system 1000 is shown to include a hospital bed 1002 and/or other area (e.g., a treatment room) which may be used by a patient 1004. Remote control 1006 can be used to control various settings around hospital bed 1002.

Remote control 1006 can include an interface for receiving identification information from a patient (e.g., a patent ID number, a unique identifier for the patient, a social security number, etc.). The identification information can be used to change various environment settings of the environment of and around hospital bed 1002. Patient 1004, for example, may change a temperature setting using remote control 1006. Remote control 1006 may be configured to wirelessly communicate with various components of BAS 100 (e.g., HVAC control system 520, lighting system 522, or another system 524) and to provide identification information and/or setting information to the BAS. According to various alternative embodiments, remote control 1006 can be communicably coupled via a wired connection to BAS 100.

Hospital system 1000 may include a sensor 22 for detecting the identity of the patient via a portable wireless device (e.g., RFID tag, RFID bracelet, mobile phone, key fob, key card, etc.) carried by the patient, according to an exemplary embodiment. Sensor 22 may be located within and/or coupled to remote control 1006, providing remote control 1006 with identification information for processing and/or for forwarding to another system (e.g., a BAS system or device). For example, remote control 1006 may transmit the identification information to systems 520, 522, 524 and using the identification information, systems 520, 522, 524 may adjust various personal settings for patient 1004.

Hospital system 1000 includes a patient database 1008. Patient database 1008 may store various personal settings and preferences for a patient. For example, database 1008 can contain information regarding a preferred temperature for patient 1004 (e.g., by relating an identifier for the patent's RFID bracelet to the preferred temperature) and HVAC control system 520 can adjust the temperature of building areas when patient 804 is detected in the area.

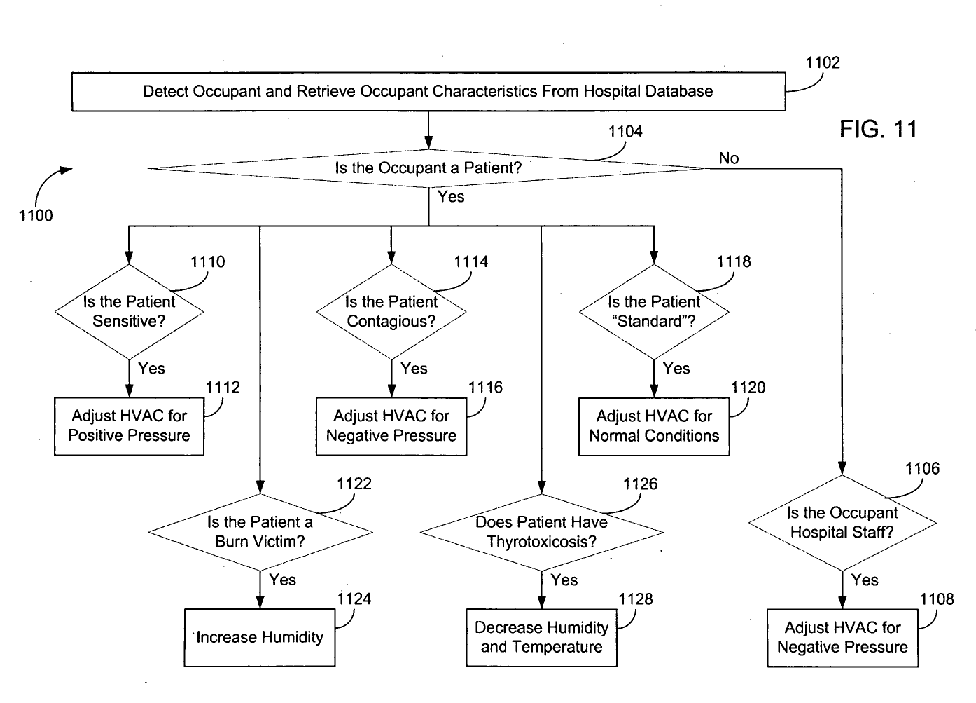

Referring to FIG. 11, a flow chart of a process 1100 for adjusting environment settings for detected occupants of a hospital area is shown, according to an exemplary embodiment. Process 1100 is configured to determine the condition of a patient (or other occupant) of a hospital area and to adjust the environment conditions of the hospital area accordingly. A portable wireless device associated with an occupant of a hospital area may be detected and occupant characteristics may be retrieved from a hospital database (step 1102). A determination is made as to if the occupant is a patient (step 1104). If the occupant is not a patient, process 1100 may include determining if the occupant is hospital staff (e.g., a janitor or cleaner) (step 1106). If the occupant is hospital staff, the hospital system may adjust the HVAC of the hospital area for negative pressurization of the area (step 1108) such that no disturbed particles (e.g., dust, bacteria, etc.) are spread throughout the hospital area, avoiding potential health hazards for patients. Steps 1106 and 1108 may include any other variety of adjustments for the presence of non-patient occupants.

If the occupant is a patient, various conditions may be checked for and the environment of the hospital area may be adjusted accordingly. If the patient is sensitive to other diseases (step 1110), the HVAC controlling the building zone that the patient will be in (e.g., the patient's treatment room) may be adjusted for positive pressure (step 1112). In this manner, the system can automatically provide a “protective-environment” room such that excess airborne contaminants are prevented from entering the room. If the patient is contagious (step 1114), the HVAC of the building zone may be adjusted for negative pressure (step 1116) to provide an “airborne-infection” room such that infectious agents from the patient are contained. If the patient is “standard” (e.g., the patient is not sensitive or contagious) (step 1118), the HVAC of the building zone that the patient is sensed to occupy may be adjusted for normal conditions (step 1120).

Additionally, process 1100 may be used to adapt hospital room environments for other conditions associated with the portable wireless device carried by a patient. For example, if the sensed patient is a burn victim (step 1122), the humidity in the patient's hospital room may be increased for patient comfort and to speed healing (step 1124). If the patient has thyrotoxicosis (step 1126), the humidity and temperature of the hospital room may be decreased to improve the conditions for the patient (step 1128).

The hospital room environment may be altered in a variety of ways based upon the patient condition (e.g., the temperature, humidity, pressure, or ventilation of the room may be altered). For example, temperature and humidity may be increased or decreased based on the condition of the patient of the type of hospital room (e.g., intensive care unit, surgery or radiology area, diagnostic area, recovery area, nursing area, any general area or other type of area), a pressure relationship with an adjacent room may be increased or decreased, and ventilation may be adjusted (e.g., the minimum number of air changes of outdoor air or minimum total air changes per hour may be adjusted).

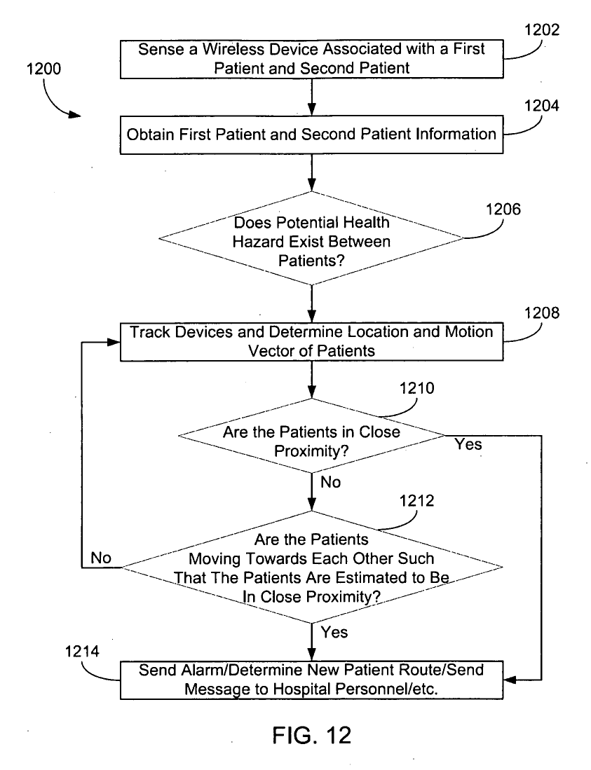

Referring now to FIG. 12, a flow chart of a process 1200 for a tracking and processing patient movement in a hospital is shown, according to an exemplary embodiment. The tracking and alerting system may be used to track patients with various conditions and to discover potential infection hazards regarding the patients (and other occupants) of the hospital. The system may detect a portable wireless device associated with a first patient and a second patient (step 1202). Using the identification, the system may obtain first patient and second patient information (step 1204). Patient information may include the medical condition of the patient and details regarding various allergies, symptoms, and health risks associated with the patient. Step 1204 may include accessing a database or other hospital system to obtain various disease and condition information for a condition associated with a patient. Using the patient information, the system may determine if a potential health hazard exists between the two patients (step 1206). If such a health hazard exists, the system may choose to closely monitor the location and movement of the patients (e.g., by requesting system updates and/or communications on a more frequent basis).

The wireless devices of the patients may be tracked and the location and motion vector of the patients may be determined (step 1208). The location may be used to determine if the patient is in a proper location (e.g., there is no patient risk associated with a patient condition). The motion vector may allow the system to determine a route and destination for the patient. According to alternative exemplary embodiments, route and destination information for the patient may be provided by hospital personnel (e.g., via room movement plans, treatment plans, and the like).

Using the location information, the system may determine if the patients are in close proximity (step 1210) or if the patients are moving towards each other such that the patients are estimated to be in close proximity (step 1212). If either is true, then a potential health hazard may be introduced to the patients and/or other occupants of the hospital. Various actions may be taken in response to the potential health hazard (step 1214). According to one exemplary embodiment, an alarm may be sounded for affected hospital areas. According to another exemplary embodiment, the system may determine a new route for one or both patients and relay the route information to hospital personnel (e.g., at a computer display, at a personal digital assistant, a pager, a text messaging device, a cellular phone, etc.).

Step 1208 may be used to generally track a patient, according to an exemplary embodiment. For example, a patient may be located at all times using step 1208 (e.g., if a patient is missing, the system may be used to locate the patient). The patient may be going for lab work, an x-ray, MRI, etc., and the system may be used to track the location of the patient as the patient goes to and from the various stations and equipment.

While the exemplary embodiments illustrated in the figures and described herein are presently preferred, it should be understood that the embodiments are offered by way of example only. Accordingly, the present application is not limited to a particular embodiment, but extends to various modifications that nevertheless fall within the scope of the appended claims.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

It should be noted that although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A method for providing control to a building zone using a building automation system and a portable wireless device located within the building zone, the method comprising:
identifying the portable wireless device using wireless communications;
retrieving information from a memory device, the retrieved information specific to the identified portable wireless device, wherein the retrieved information comprises a user preference relating to the building automation system; and
adjusting a parameter of the building automation system based on the retrieved information.

2. The method of claim 1, wherein adjusting the parameter of the building automation system comprises:
determining a volumetric flow rate setpoint for the building zone using the retrieved information; and
sending the volumetric flow rate setpoint to a ventilation system controller.

3. The method of claim 1, wherein the retrieved information is preferred temperature information and wherein adjusting the building automation system comprises setting a temperature setpoint for the building zone to equal the preferred temperature information.

4. The method of claim 1, further comprising:
identifying a second portable wireless device located within the building zone;
retrieving second information from a memory device specific to the second identified portable wireless device; and
determining an average preferred temperature for the building zone using the retrieved information and the second information;
wherein adjusting the parameter of the building automation system based on the retrieved information comprises adjusting a temperature setpoint for the building zone to be the determined average preferred temperature for the building zone.

5. The method of claim 1, further comprising:
identifying a second portable wireless device located within the building zone;
retrieving second information from a memory device specific to the second identified portable wireless device; and
making a second adjustment to a second parameter of the building automation system based on the retrieved second information.

6. The method of claim 1, wherein the user preference is at least one of a white noise volume preference, a lighting preference, a heating preference, and a cooling preference.

7. The method of claim 1, wherein the retrieved information includes the user preference and a second user preference and wherein the user preference is a temperature preference and the second user preference is a lighting preference.

8. A controller for adjusting a parameter of a building automation system using a portable wireless device located within a building zone, the controller comprising:
a communications device configured to receive first information from the portable wireless device located within the building zone;
a memory device storing second information specific to the first information; and
a processing circuit configured to retrieve the second information from the memory device and to receive the first information from the wireless sensor, the processing circuit retrieving the second information by identifying the first information and accessing the second information from the memory device, the processing circuit configured to adjust a building automation system setting based on the retrieved second information.

9. The controller of claim 8, wherein the portable wireless device is at least one of an RFID tag, a mobile phone, a pager, a portable media device, a portable digital assistant, a mobile personal computer, and a laptop.

10. The controller of claim 8, wherein the communications device is at least one of a ZigBee compatible transceiver, a Bluetooth compatible transceiver, and a WiFi compatible transceiver.

11. The controller of claim 8, wherein the user preference is at least one of a white noise volume preference, a lighting preference, a heating preference, and a cooling preference.

12. The controller of claim 8, wherein the retrieved information is preferred temperature information and wherein adjusting the building automation system setting comprises setting a temperature setpoint for the building zone to equal the preferred temperature information.

13. The controller of claim 8, wherein the processing circuit is configured to transmit an adjustment signal to a supervisory controller of the building automation system.

14. The controller of claim 8, wherein the processing circuit is further configured to determine a volumetric flow rate setpoint for the building zone using the retrieved information; and wherein the processing circuit is configured to transmit an adjustment signal to an actuator of the building automation system to adjust the building automation system setting; and wherein the adjustment signal is based on the volumetric flow rate setpoint.

15. The controller of claim 14, wherein the retrieved information includes the user preference and a second user preference and wherein the user preference is a temperature preference and the second user preference is a lighting preference.

16. A system for providing control to a building zone using a building automation system and a portable wireless device located within the building zone, the system comprising:
a sensor configured to identify the portable wireless device using wireless communications;
a processing circuit communicably coupled to the sensor and configured to retrieve information from a memory device, the retrieved information specific to the identified portable wireless device;
wherein the processing circuit is further configured to adjust a setting of the building automation system using the retrieved information specific to the identified portable wireless device.

17. The system of claim 16, wherein the retrieved information is at least one of temperature preference information, lighting preference information, humidify preference information, and ventilation preference information.

18. The system of claim 16, wherein the retrieved information specific to the identified portable wireless device is a hospital occupant characteristic and wherein the hospital occupant characteristic identifies the hospital patient associated with the portable wireless device as at least one of contagious and ultra-sensitive, and wherein the setting is ventilation pressure.

19. A computer readable medium storing program code for causing a controller to provide control to a building zone using a building automation system and a portable wireless device located within the building zone, the computer readable medium comprising:
program code for identifying the portable wireless device using wireless communications;
program code for retrieving information from a memory device, the retrieved information specific to the identified portable wireless device, wherein the retrieved information comprises a user preference relating to the building automation system; and
program code for adjusting the building automation system parameter based on the retrieved information.

20. A server computer configured to provide program code to a client computer, the program code for causing the client computer to provide control to a building zone using a building automation system and a portable wireless device located within the building zone, the server computer comprising:
a communications interface for communicating with the client computer; and
a processing circuit for accessing a memory device storing the program code, the program code comprising:
program code for identifying the portable wireless device using wireless communications;
program code for retrieving information from a memory device, the retrieved information specific to the identified portable wireless device, wherein the retrieved information comprises a user preference relating to the building automation system; and
program code for adjusting the building automation system parameter based on the retrieved information.
